(19) United States
(12) Patent Application Publication
(10) Pub. No.: US 2013/0164775 A1
(43) Pub. Date: Jun. 27, 2013

(54) MONITORING CELL AND METHOD OF ANALYZING CELL AND TISSUE GROWTH

(71) Applicant: Fraunhofer-Gesellschaft zur Foerderung der angewandten Forschung e. V., Munich (DE)

(72) Inventors: Holger LAUSCH, Jena (DE); Michael Brand, Jena (DE); Michael Arnold, Jena (DE)

(73) Assignee: Fraunhofer-Gesellschaft zur Foerderung der angewandten Forschung e. V., Munich (DE)

(21) Appl. No.: 13/721,399

(22) Filed: Dec. 20, 2012

(30) Foreign Application Priority Data
Dec. 23, 2011 (DE) 102011057045.4

(51) Int. Cl. G01N 27/327

(52) U.S. Cl. CPC G01N 27/327
USPC 435/29; 435/287.1

(57) ABSTRACT

The invention relates to a monitoring cell for analyzing a cell and tissue growth, in which a carrier object (8) and a cell substrate (9) are arranged with respect to one another, separated by a gap (50), in order to simulate in vitro an in situ gap situation between an implant and a tissue surface in a realistic manner. The invention also relates to a method for non-test-abortive, multidimensional in vitro monitoring of the growth of cells or tissues. Electrodes (20) are used to generate spatially and temporally defined electric fields and to capture electrical measurement variables, from which information in respect of the growth of the cells can be derived.

The present application claims priority under 35 U.S.C. §119 of German Patent Application No. 10 2011 057 045.4, filed Dec. 23, 2011, the entire disclosure of which is expressly incorporated by reference herein.

### BACKGROUND OF THE INVENTION

1. Field of the Invention

The invention relates to a monitoring cell for analyzing cell and tissue growth, as known generically from DE 10 2009 039 956 A1. The invention furthermore relates to a method of analyzing a cell and tissue growth.

2. Background Information

Knowledge of the interactions of living cells and tissue with surfaces and materials is of great interest for a multiplicity of medical and material-scientific developments and applications, for example during the development and testing of implants. In order to be able to examine such interactions, use is made of a number of examination methods which are known from the field of cell biology. In these examination methods, parameters such as the adhesion, the proliferation, the migration or the differentiation of cells, cell structures, cell layers, and also the development of the extracellular matrix (ECM) are generally examined in a two-dimensional and test-abortive fashion. Test-abortive examinations are those in which growth or development of cells or tissues is made possible over a specific period of time or up to a specific stage but in which the cells or tissues are prevented from further growth or further development for examination purposes. Conventional periods of time are, for example, 3, 6, 24 and 48 hours, as well as 2, 5, 7, 10 and 20 days. A disadvantage in the application of test-abortive methods lies in the loss of information in respect of how the specifically examined cells or tissues would have continued to develop. From the point of view of a statistical evaluation of such examinations, a correspondingly large number of trial repetitions are required in order to obtain sufficiently reliable results. Moreover, it is possible that the predetermined time of the abort of a specific test turns out to be inexpedient for a result; this cannot be remedied even by a relatively large number of repetitions of the test.

In the known examination methods, the parameters mentioned above in an exemplary fashion are usually examined isolated from one another or in succession, but not in parallel. Such a procedure is advantageous if specific conclusions should be drawn in respect of individual parameters and interactions should be avoided.

However, for the development of, for example, implants or tissue replacements and for the suitability thereof for use in the human or animal body, it is necessary to examine a complex situation with a multiplicity of interactions, as will in actual fact be present later when the implant or the tissue replacement is used in vivo.

An important factor in the use of implants or tissue replacements is that when these are introduced into the body, into an organ or into a tissue (subsumed as tissue below) there is a gap situation between the implant and the tissue present.

The prior art currently does not disclose any solution by means of which a gap situation, occurring in vivo, is simulated and is able to be examined sufficiently closely to reality in vitro.

Although DE 10 2009 039 956 A1 for example discloses devices in which, in an interior of a device for temporal cell and tissue analysis (monitoring cell), there are walls protruding into said interior, between the end faces of which walls a gap is formed, through which gap a medium, e.g. a nutrient solution, flows, this specific gap situation serves to guide cells in the direction of a reaction surface. Electrodes, arranged in the interior, for generating electric fields serve to align and direct the cells in the medium in the direction of a defined analysis surface. It is furthermore known that electric fields can be used to examine cells and tissues. Here, information in respect of changing properties of the cells or tissues is derived from electric fields and the changes therein.

Thus, from DE 103 45 573 A1 there is known a method in which the barrier function of a cell layer is established by determining the transepithelial or transendothelial electrical resistance as a measure for the impermeability of the cell/cell contacts of a cell layer to the passage of inorganic ions. Here, the electrodes are positioned above and below a cell layer to be examined. If the substrate to which the cells should adhere is impermeable, the electrical properties of the cells are analyzed by impedance spectroscopy.

According to the articles by Wegener et al. (2000) Brain Research 853: 115-124; Lohmann et al. (2004) Brain Research 995: 184-196; Arndt et al. (2004) Biosensors and Bioelectronics 19: 583-594, the electrical resistance of the barrier-forming cell/cell contacts, the impedance contributions of the cell/substrate contact and the capacitance of the plasma membrane are extracted from the impedance spectra. However, the use of global electrodes which are arranged above and below the cell substrate only renders it possible to follow vertical and not horizontal growth processes.

Further options for examining the growth of cells or tissues consist of an observation through suitable windows by means of optical sensors, with it only being possible to observe the surface dynamics. By arranging the cell membranes/cell carriers on one electrode or between two horizontal electrodes (ring/point, plate/plate, etc.) and between radial electrodes, it is only ever possible to measure integrated or one-dimensional resolutions of two-dimensional, planar areas. The integrated expression obtained thus does not resolve the planar area, which is generally indicative of the detection of monolayers. This does not allow the complexity and multilayer properties of, for example, the extracellular matrix (ECM) or of biofilms to be followed in a spatially and temporally differentiated fashion.

What is common to all the aforementioned solutions is that these do not reproduce the in situ situation of two opposing interfaces with a gap situated therebetween. Moreover, the gravitational aspect of cell/tissue development is disregarded in all of these arrangements, or lifted by fluidic arrangements, despite the atypical “flattening” of cultivated cells on the base of culture dishes or on inorganic membranes being sufficiently well known (cf., for example, Minuth et al. “3-D-Kulturen” [3D cultures], pages 395 and 396).

### SUMMARY OF THE INVENTION

The invention is based on the object of proposing an option for analyzing a cell or tissue growth, in which an in vivo gap situation between the surfaces of a carrier object and a cell substrate is reproduced.

The object is achieved by a monitoring cell for analyzing a cell and tissue growth, comprising a housing with walls surrounding an interior and at least one base plate, wherein the housing is provided with at least one media feed on at least one side of the interior and at least one media discharge on at least one other side of the interior and with a number of electrodes arranged in the interior. The monitoring cell according to the invention is characterized by there being is at least one holder device for holding at least one carrier object and at least one holder device for holding at least one cell substrate or at least one holder device for holding at least one carrier object and at least one cell substrate. There is, at least at the start time of the analysis, a gap between carrier object and cell substrate such that this reproduces an in vivo situation, between a carrier object to be colonized and a substrate, to be copied in vitro. The electrodes are configured both for generating spatially and temporally defined electromagnetic fields and as means for measuring electrical variables (referred to as measurement means in the description below).

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

In the following text, the phrase growth of cells or tissues is understood to mean all processes connected to growth, such as, for example, cell migration, differentiation and proliferation. The monitoring cell according to the invention can moreover also analyze processes complementary to growth, such as the death and degradation of cells (apoptosis, suppression) and changes in the cell substrate and in the carrier object.

Within the meaning of this description, a gap can be a spatial gap. The latter is present if carrier object and cell substrate are in actual fact arranged at a distance from one another. A gap should also be understood to mean a material gap. By way of example, a material gap can be present due to biological (bioinert, e.g. cytotoxic regions), (bio)physical properties such as strong physical gradients or material-specific gradients, or material properties, e.g. an abrupt change of surface roughness. All interface situations which have a gap effect are encompassed by the term gap.

A carrier object is understood to mean any body made of any material which can be introduced into the holder device. However, carrier objects are preferably biodegradable or non-biodegradable implants or tissue replacements. A cell substrate can be any material or substance mixture by means of which cells are provided (examples: colonized or inoculated nutrient media such as agarose, alginate, monocultures and cocultures). The monitoring cell according to the invention can also be used for analyzing biofilms, which, for example, are formed by bacteria, fungi, algae and protozoa. During growth, carrier objects and cell substrate can be covered by a large number of cells, between which it is also possible for an ECM to form or for tissue to be differentiated. In the following text, reference is made to cells for simplicity, but this should comprise all possible cell-biological structures and units, and also unicellular and multicellular organisms. Carrier object and cell substrate are held and fixed by the respective holder device.

The terms biodegradable and degradable mean that the relevant material is degraded by biochemical reactions of the tissue (e.g. by enzymes) and, possibly, in conjunction with biophysical processes.

A preferred embodiment of the monitoring cell according to the invention is embodied in such a way that there are two projections with end faces in the interior and the holder devices are arranged on the end faces.

Further measurement means can be arranged outside of the gap, but preferably within the interior. By way of example, the further measurement means can be e.g. temperature, pressure, oxygen or pH-value sensors.

It is also advantageous if there is an evaluation and storage unit, which is connected to the electrodes and available further measurement means. As a result of such an evaluation and storage unit, the measurement data captured by the measurement means and also by the electrodes which function as measurement means can be evaluated and stored, preferably centrally.

Electrodes can be embodied as electrically conductive, non-insulated electrodes, as a result of which a current flow is made possible between at least two electrodes and through the medium. Non-insulated electrodes render it possible to carry out measurements based on current flow. If the electrodes are designed in an electrically insulated fashion, these can be used to generate electric and/or electromagnetic fields in the interior and can use these fields for the measurement. The electrodes can be embodied in various shapes, for example in the shape of a strip, plate or point, or can be combined to form so-called clusters. The electrodes can be fixedly arranged or freely positioned in the interior. As a result, there advantageously is great flexibility in terms of the design of the measurement arrangements. It is possible to arrange a plurality of non-insulated electrodes, a plurality of insulated electrodes and combinations of non-insulated and insulated electrodes. It is advantageous if the shape, arrangement and way in which the electromagnetic fields are generated allow a spatially resolved capture of the measurement variables. The electrodes can also be segmented. By way of example, this can be achieved by a spatially defined arrangement of a number of electrodes, wherein a location of the capture of the measurement variables can be derived from the differences in the measurement variables at each electrode and knowledge of the arrangement of the respective electrodes.

The electrodes provided in the arrangement can be varied and differentiated in a number of ways: firstly, in respect of their connection to the conductive nutrient solution/medium into conductive (wet) and non-conductive (dry) electrodes in the form of electrically insulated electrodes and also electrically conductive, galvanic electrodes. The electrodes can also be distinguished in respect of their geometry, for example into point, line and plate electrodes, and their arrangement amongst themselves, for example, into individual electrode arrangements, grid arrangements (cluster electrodes) and free arrangements. Furthermore, in theory it is possible to use any combination of the provided electrodes for exciting e.g. the cells and/or for measurements.

A preferred arrangement of the electrodes sees these being arranged next to the end faces of the projections on at least two sides. Such an arrangement renders it possible to generate electric fields on both sides of the gap, e.g. on the inlet side and the outlet side. It is also possible for at least one electrode to be arranged on at least one end face as central electrode. The central electrode is then situated behind the carrier object or the cell substrate, and so an electric field emanating from the central electrode, or a current flow between the central electrode and at least one further electrode, passes through the carrier object or the cell substrate. Some or all of the electrodes can be moved, and so electrodes can be arranged in the interior in three dimensions. There can also be central electrodes on each of the end faces such that a measurement can be made over the gap width. The central electrodes can be adjusted in the direction of the gap.

An expedient embodiment of the monitoring cell according to the invention consists of flow barriers being arranged in the interior, as a result of the arrangement of which the medium is routed through the gap. This promotes reliable wetting, and a reliable supply, of the cells. A flow can flow laterally around the cell substrate and pass into the gap or flow through the latter. Here, the lateral regions of the cell substrate are supplied with e.g. nutrients by means of the regions where the flow approaches laterally; the central region of the cell substrate can be supplied via the gap. It also serves to guide the flow if each projection has edges which slope away at an acute angle with respect to the end face. It is also possible for the medium to be introduced into the interior or the gap at a specific pressure, as a result of which it is possible to simulate a specific pressure load on the cells. It is for this reason that the monitoring cell can be connected to a defined pump and reservoir and to a micro-droplet removal system in order to ensure the nutrient, oxygen or signal-substance supply, or combinations thereof, in the gap between carrier object and cell substrate and in order to be able to introduce other biological organisms into the gap in a targeted fashion. The medium can be supplied continuously or discontinuously.

Moreover, such an arrangement can generate a defined pressure and flow-load situation in the gap region in a temporary, periodical or permanent fashion, for example for mechanotransductive simulations of load and movement situations. It is possible to generate defined gradients (e.g. pressure, force, surface tension) which are comparable to an in situ situation in the case of physical stress.

It was found to be an advantageous embodiment of the monitoring cell according to the invention if the monitoring cell is connected to a controlled drive, by means of which the monitoring cell can be moved in a controlled fashion. Two- or three-dimensional movements of the monitoring cell can be realized with such an embodiment. By way of example, it may be possible to shake the monitoring cell in a defined seesaw-type, tilting, reeling, ping pong-type or circular fashion in order to be able to simulate cell and tissue growth processes and also the biofilm development under rest conditions and under defined movement situations. Influences of gravity on the growth or the suppression thereof can also be lifted. As a result, a realistic reproduction of the in vivo situation is possible.

In order to be able to set a gap width of the gap, it is expedient that at least one of the holder devices can be adjusted in the direction of the gap.

The gap width to be set depends on the situations to be analyzed in each case, on the carrier objects and on the cell substrates. Thus, a gap width of between 150 and 400 μm is expedient when analyzing the growth of human bone cells (osteoblasts). The selected gap width depends on the combinations of carrier object and cell substrate to be analyzed, and on the organism for which the situation is simulated in vitro. Thus, different gap widths can be selected and set for large organisms, e.g. for horses or camels, than for smaller organisms, such as e.g. for a mouse. The gap width can preferably be set to less than 3 mm. In an advantageous embodiment of the monitoring cell, the gap width can also be readjusted during an analysis such that, for example, stretching, which is indicated medically and undertaken in a defined fashion, with a tissue treated by an implant can be simulated.

As a result of subdividing the carrier object into partial carrier objects and the cell substrate into partial cell substrates, it is possible to analyze a plurality of growth processes in one monitoring cell. The subdivision can also serve to include controls and for the analysis of samples within the meaning of an experimental trial arrangement according to scientific and statistical standards (e.g. for an analysis by means of variance analysis). The individual partial carrier objects or partial cell substrates can adjoin one another or be separated from one another by a gap or a barrier which cannot be colonized (which is bioinert, e.g. cytotoxic).

The subdivisions of carrier object and cell substrate are preferably complementary to one another in shape, size and position such that the subdivisions lie opposite to one another in the monitoring cell. It is also possible for at least one of two subdivisions lying opposite to one another to be neutral, i.e. uncolonized or uncolonizable.

By way of example, there can be different cells, co-cultures or reservoirs for microbes (prokaryotes and/or eukaryotes), bacteria or fungi, and combinations thereof on the partial cell substrates.

The carrier objects, the cell substrate or both can be embodied as already cell or tissue colonized elements, wherein these can be used as biosensors for biological, biochemical or chemical substances, elements, isotopes or compounds which can be introduced in a defined fashion by means of the medium.

It is possible within the meaning of the invention to position the carrier object and the cell substrate in such a way by means of the holder devices that carrier object and cell substrate lie next to one another and the gap is formed between carrier object and cell substrate. As a result of a correspondingly selected arrangement of the electrodes, it is possible to analyze the carrier objects and cell substrates arranged thus.

By way of example, it is possible to arrange a central electrode which, in a plane, is wholly or partly surrounded by the cell substrate. There may be a barrier zone between the cell substrate and the central electrode. A further central electrode or a plurality of electrodes can be arranged opposite to the central electrode, separated by a gap. A medium is present, at least in the gap.

The object is furthermore solved by a method for non-test-abortive, spatial-temporal in vitro monitoring of the growth of cells or tissues. The method according to the invention comprises the steps of accommodating a carrier object in a holder device of a monitoring cell and of accommodating a cell substrate in a further holder device of the monitoring cell such that there is a gap with a gap width between the carrier object and the cell substrate.

A medium is supplied; which serves to wet and supply the cells of the cell substrate and all cells developing during the growth. The medium can wholly or partly fill the interior. Spatially and temporally defined electric and/or electromagnetic fields are generated in the monitoring cell and measurement variables of the electric and/or electromagnetic fields are captured and stored.

Gap widths of less than 3 mm are preferably set in the method according to the invention.

A preferred way of conducting the method according to the invention lies in capturing and storing initial measurement variables in respect of an initial measurement time and using the initial measurement variables as reference measurement variables for measurement variables captured at later measurement times. Thus, it is possible for a measured actual situation to be compared to a specific initial situation and for at least one temporal change to be detected in respect of the growth and in respect of the increasing, stagnating or even decreasing number of cells accompanying this.

Information in respect of the growth of the cells or tissue can be derived from the changes in the measurement variables captured and stored at different measurement times. An advantageous embodiment of the method according to the invention sees the measurement variables being captured in a spatially resolved fashion. The measurement data captured in a spatially resolved fashion can be represented graphically and the information in respect of the growth of the cells or tissue can be derived from the graphical representation. By way of example, a spatially resolved measurement variable can be associated with one or more pixels of a display, and the value of the measurement variable can be associated with a brightness or color value (pixel value), e.g. a grayscale value. The distribution of the pixel values can serve as a data record for an image-assisted analysis. If measurement variables of different measurement times are available, it is also possible to use as a data record the differences in the pixel values at the measurement times.

The derived information can be compared to, evaluated with and validated with the entries in a database. The databases can be already available databases, databases generated during the analysis or combinations of available and generated databases.

The monitoring cell according to the invention and the method according to the invention particularly advantageously render it possible to examine a suitability of different materials or material composites for the production of implants for individual patients. To this end, carrier objects are made of the materials/material composites to be examined and used in a monitoring cell according to the invention for carrying out the method according to the invention. Here, in addition to the materials of the carrier objects, it is also possible to vary and examine the shape and/or surface structure (e.g. roughness, porosity, substances applied to the surface by chemical and/or physical means) thereof. This procedure renders it possible to find the best possible individual combination of properties, e.g. determined by material and surface structure, of an implant and a patient.

In an advantageous embodiment, it is possible to use cells (autologous cells) of a specific patient (autologous cells) as cell substrate in the method according to the invention. In a first embodiment, the carrier object can be formed from a selected material with selected properties. Information in respect of the growth of the cells or tissue is derived on the basis of the changes in the measurement variables captured and stored at different measurement times. A comparison of information obtained during the use of different carrier objects renders it possible to select a material or a material composite which enables desired colonization by the e.g. autologous cells. By way of example, dynamics, a quality (e.g. homogeneity of the colonization) and/or a quantity (e.g. colonization density) can be used as a criterion for the selection.

A further embodiment of the monitoring cell according to the invention and the method within the meaning of this invention enables a simultaneous test of a plurality of carrier objects. To this end, a plurality of carrier objects can be arranged in the monitoring cell at the same time. It is also possible to subdivide the carrier object into a number of partial carrier objects. These partial carrier objects can have different properties. Thus, the partial carrier objects can consist of different materials and/or have different properties. It is also possible for at least two partial carrier objects to consist of the same materials and/or have the same properties. By way of example, this is how a test-internal replica is made.

The partial carrier objects can be combined with partial cell substrates. In one embodiment, a partial cell substrate can be associated with each partial carrier object. It is also possible to associate one partial cell substrate with at least two partial carrier objects.

In addition to the combination options of (partial) carrier object(s) and (partial) cell substrate(s) listed above in an exemplary fashion, it is also possible to vary the properties of the medium, e.g. the composition, pH value, oxygen content, temperature, etc. thereof.

By means of the above-described embodiments of the monitoring cell according to the invention and the method according to the invention, the invention can be used to establish best-possible combinations of materials, material composites and the properties thereof with properties of cells of individual patients in a very advantageous fashion. Here, the option of a realistic reproduction of an in vivo situation by means of the monitoring cell, and the realistic and individual testing option of different materials of carrier objects made possible thereby, is of particular advantage.

It is possible to influence the growth of the cells by introducing stimuli into the interior. Such stimuli can be chemical substances which have a stimulating effect on the growth, such as, for example, growth factors, nutrients, hormones and energy equivalents. It is expedient to use the medium to supply such chemical substances as would also be present in the reproduced in vivo system at a specific time. As a result, an in vitro reproduction of the biochemical conditions changing over time is also possible in a very advantageous fashion.

The chemical substances can also be other substances which can also bring about negative or no effects on the growth. It is possible to supply the medium in order to replace the medium at regular intervals, to supply a medium which has been modified in its properties in a defined manner or different media. Properties can, in particular, be the composition of the medium. Furthermore, it is possible to couple defined physical effect factors, such as mechanical, electric, electromagnetic or magnetic fields and combinations thereof, into the interior. It is possible for gradients of physical effect factors to be generated in the interior.

The electrodes, which can be electrically insulated or, in a conductive fashion, be connected to one another in a variable fashion and which can be excited in a frequency-based fashion, can be used to monitor and document migration, adhesion, proliferation, differentiation and formation of an extracellular matrix (ECM), the formation of monolayers and multilayers, maturation or biofilm formation, suppression and other cellular processes via changes in the measured electrical signals (e.g. resistances, conductivities, potentials, capacitances).

The arrangement according to the invention serves to carry out a non-test-abortive multidimensional method for analyzing, monitoring and documenting in vitro cell growth in a definable, three-dimensional interface situation between a tissue-like region (cell substrate) and a region in the form of degradable or non-degradable implant surfaces and/or tissue replacements (carrier object); in other words for monitoring growth processes in a system used to reproduce the in situ situation. It is possible to examine materials to be applied in a medical context in respect of the bioactivities and anti-inflammatory properties thereof in respect of human, animal (e.g. osteoblasts, endothelial cells, squamous epithelia, fibroblasts) or other cells (e.g. bacteria, fungi, other biofilm-formers and other microorganisms).

Monitoring of cell growth processes in an in vivo/in situ-similar situation is brought about by spatially resolved measurements of the temporal change of electrical parameters by means of impedance-spectroscopic measurement methods and capacitive and potential measurements. The whole arrangement according to the invention remains unchanged in its basic design during an analysis and is provided with defined electrode arrangements. With this initial equipment, including the cell substrate, the carrier object and the medium, the arrangement exhibits a respectively different but defined and reproducible initial electrical behavior during a measurement at different electrode combinations or at different locations of the electrodes. This is due to the materials used in the arrangement or used during equipping, the electrical properties thereof, their interfaces amongst themselves and their geometric arrangement with respect to one another. Overall, these parameters fix the potential distribution or the signal paths in the case of electrical excitation of the arrangement with a defined DC voltage or, preferably, a sinusoidal AC voltage and, in general, result in a typical spatially, amplitude and frequency-dependent response behavior.

Effects caused by cell growth processes as the test progresses in time lead to changes in the geometric arrangement of the materials (e.g. in the case of migration of cells or degeneration of the carrier material) and/or to changes in the materials per se (effects which can be captured on the composition of the medium) and therefore to changes in the electrical signal paths and/or the electrical measurement variables which can be captured, such as the conductivity of the materials. The listed changes are, with regard to the utilized electrode arrangements, expressed in respect of the electrical behavior of the arrangement in the monitoring cell. From the time profile of the differences between initial electrical property and current measurement and/or between successive measurements in time and variables derived therefrom, such as the rise behavior or changes in the frequency and amplitude dependencies, and/or by fitting (matching) the current measurement to an electric equivalent circuit for the arrangement, which takes the transition resistances and capacities of the materials and media into account in a suitable fashion, it is possible to draw conclusions in respect of the cell growth processes such as migration and adhesion behavior and also proliferation or suppression. By correlating the electrical measurement results with those from established cell-biological examinations, it is possible for the first time to determine in a defined fashion expedient times at which the examined samples are, for further evaluation, supplied to test-abortive established cell-biological examinations. Moreover, it is also possible to plan accompanying non-test-abortive examinations (e.g. micro-droplet analyses) in a meaningful way and/or to undertake modifications of the environmental conditions or other test parameters, for example the targeted control of the nutrient inflow into the gap via the medium.

In order to excite the arrangement, it is possible to use both defined individual frequencies and whole bands of frequencies within the meaning of a frequency sweep and also direct signals. Moreover, it is possible to vary the signals of the excitation in terms of the amplitudes and waveform thereof.

To this end, the electrodes present, more precisely the electric and/or electromagnetic fields generated thereby and the measurement variables captured by the electrodes are advantageously combined in such a way that, for example, measurements along an arrangement of carrier object and cell substrate or a measurement through the carrier object, through the cell substrate or through both are made possible. Different electrode combinations for excitation and measurement are also possible.

As measurement variables for characterizing cell growth and cell migration processes for example, use can optionally be made of impedances in the form of an amplitude ratio between voltage and current and phase angles of both variables, admittances and all variables derived therefrom, more particularly also electrode-related capacitances, inductances, ohmic resistances or conductivities of materials and material combinations.

Moreover, it is possible, with the aid of projection and reconstruction algorithms, to generate graphical 2D and 3D representations of the cell-biologically induced intensities or intensity variations in the electrical parameters from the response behavior of the system during the measurement between respectively defined electrodes as reference electrodes and variably selected electrodes, making use of the arrangement, the geometry and the location of reference electrodes and counter electrodes. By way of example, these can be converted into color-coded or grayscale value-coded images and/or 3D point clouds and examined further using established image processing algorithms and/or statistical methods (e.g. cluster analyses). This renders it possible to use the measurement method as imaging method for cell growth-dependent processes such as, for example, the localization of colonizing zones on a carrier object or of biochemical enrichment and depletion zones in the nutrient solution or in the material of the carrier object. In order to generate the location-dependent representations, electrodes with spatial affinity to the point of interest (POI) are preferably selected as reference electrodes, for example central electrodes in the vicinity of the carrier object. In order to ensure the application of various reconstruction and projection algorithms, electrodes that allow a signal flow in different directions from the POI preferably serve as variably selected electrodes, for example electrodes arranged laterally with respect to the end face of the projection.

Alternatively, it is also possible to apply defined currents to the arrangement via defined but variable electrode pairs and to determine the potential distribution in a region of interest (ROI) by a multiplicity of electrodes. This renders possible a reconstruction of the local conductivity distribution in the ROI and the graphical representation thereof in a manner similar to electrical impedance tomography.

A procedure for a possible metrological realization of the monitoring system is outlined below. The individual electrodes of the monitoring cell are connected to a multifunction switch or a switching matrix. This switching means realizes the combination of electrodes, described above, for the excitation and measurement by virtue of establishing the electrical contact between a defined selection of electrodes and a number of measurement lines. The measurement lines are connected to a suitable impedance analyzer or to a measurement instrument, which takes over the excitation and measurement of the signals and makes the data available via an interface. The measurement data are transmitted to a control and computation unit via the data lines. The data are evaluated, prepared and stored in this control and computation unit. The results are transmitted to the interface via data lines. An operator or a further analysis or measurement system can access the results via said interface. Moreover, from the interface it is possible, via control lines, to read status values of the individual components of the measurement system and/or to control or regulate said components. By way of example, via the control lines, it is possible by means of the multifunction switch/switching matrix to influence the electrode combination used for the measurement, vary specific parameters of the monitoring cell, such as the nutrient solution transport, set and control the measurement parameters of the impedance analyzer/of the measurement instrument and control the evaluation and storage of the data in the control and computation unit. All aforementioned components can be arranged as individual components of the system and can also be integrated in a complete system. Moreover, systems are also feasible which dispense with one or more steps of the illustrated procedure, provided that this does not have an adverse effect on the monitoring.

Workflows of typical applications such as the generation of novel test methodologies and the creation of test libraries are explained below. The individual work steps, decisions, data and results are respectively associated with the regions “monitoring cell”, “microbiology” or “monitoring management”. The goal of this procedure is to obtain suitable test parameters and abort criteria for stand-alone operation of the monitoring cell for a specific item under examination from the comparison of data from the biophysical/electrical measurements by means of the monitoring cell with the data of test-accompanying and concluding microbiological tests. These are collected as correlation pattern in the form of a signal library or as criteria for aborting the test in the form of a trigger library and are the basis for autonomous monitoring.

Proceeding from initial values, a test methodology is created for a specific item under examination. In addition to unchangeable parameters and work and method prescriptions for duly carrying out the measurements and examinations, this test methodology also contains initial values for variable test parameters of the test-accompanying microbiological tests, the biophysical measurements and the abort criteria for the monitoring. Biophysical measurements and test-accompanying microbiological tests are started with the initial values.

Within a continuous comparison, a trigger makes a decision in respect of continuing or aborting the monitoring on the basis of current abort criteria. In parallel therewith, the currently current data from the biophysical measurements and test-accompanying microbiological tests are collected for the subsequent evaluation. If the trigger provides the decision to stop the monitoring as a result of abort criteria being satisfied, concluding microbiological tests are carried out and the collected biophysical data as well as the data from the test-accompanying and concluding microbiological tests are fed to the evaluation and to a comparison (matching) and all relevant data are stored.

Identified correlation patterns between measured biophysical and microbiological parameters are added to a signal library, identified potential abort criteria are added to a trigger library. Consequences for the future test run of the measurement cell in the stand-alone operation are derived from the newly obtained insights. A monitoring cycle for further improvement of the test methodology or for generating new correlation patterns with updated abort criteria and test parameters is optionally run through again.

In principle, the process can always be run through again when an adaptation of the test methodology becomes necessary or when new cell substrates and/or carrier objects are to be examined. The already obtained insights in the form of an already created signal library and trigger library can then serve as initial values for a new test methodology.

A typical workflow for the “biophysical monitoring of cell-growth processes” application, i.e. the “stand-alone” operation of the monitoring cell, is explained below, wherein the test-accompanying microbiological tests can be dispensed with. The trigger library serves as initial point. The abort criteria relevant to the item under examination are gathered from said library, using the associated test methodology as a basis. The monitoring cell is subsequently configured accordingly and the biophysical measurements are started.

Within a continuous comparison, a trigger makes a decision in respect of continuing or aborting the monitoring on the basis of the fixed abort criteria. In parallel therewith, the currently current biophysical data are collected for the subsequent evaluation. If the trigger provides the decision to stop the monitoring as a result of abort criteria being satisfied, the biophysical data are compared to patterns from the signal library during a so-called matching step and a signal (a “matched” signal) is output. The matching step serves, on the basis of comparisons and established correlations of measurement variables respectively captured at a specific measurement time, to represent a complex state of the analyzed system of carrier object and cell substrate at this measurement time. The method according to the invention can therefore be understood as space-time simulation of the process of cell growth in the form of electrical signals, into which the complex processes taking place in the monitoring cell over a period of time are integrated. After storing the signals as data in the database, these data can be accessed during later analyses and used for the evaluation.

In a further evaluation step, optionally on the basis of additional calculations, the relevant cell-growth data is associated with the signal and subsequently processed further. All relevant data is moreover stored. The procedure can now be repeated with modified parameters (for example with other carrier objects). This renders it possible to realize an alternative comparison option for cell-growth processes on different carrier objects without the use of microbiological examinations.

The method according to the invention allows repeated measurements to be carried out on a specific combination of carrier object/cell substrate without in the process biologically changing or influencing a surface to be analyzed of the carrier objects. It is rendered possible to combine the same carrier objects with different cell substrates and to carry out meaningful comparisons. The method according to the invention ensures a very good reproducibility of the analyses. The method according to the invention provides a non-test-abortive monitoring method acting on biophysical principles, which can be used in complementary and comparative fashion to known microbiological testing and test methods. It is suitable for creating libraries and documenting the growth profile, with it being possible to dispense with time-consuming and expensive microbiological test methods.

### BRIEF DESCRIPTION OF THE DRAWINGS

The invention will be explained in more detail below on the basis of exemplary embodiments and figures. In detail:

FIG. 1 shows an upper part of a first embodiment of a monitoring cell according to the invention in a plan view from below;

FIG. 2 shows the upper part of a second embodiment of the monitoring cell according to the invention in a side view of a sectional illustration along the line A-A;

FIG. 3a shows a first embodiment of the monitoring cell according to the invention with upper and lower part, having a central electrode in the upper part;

FIG. 3b shows a second embodiment of the monitoring cell according to the invention, with a central electrode in the upper and lower part;

FIG. 4 shows a first embodiment of an electrode cluster as crossing strip electrodes;

FIG. 5 shows a second embodiment of an electrode cluster as an array of point/ring electrodes;

FIG. 6a shows a first embodiment of a carrier object with touching carrier partial surfaces;

FIG. 6b shows a second embodiment of a carrier object with carrier partial surfaces separated by a barrier;

FIG. 7 shows a first embodiment of a cell substrate with carrier partial surfaces separated from one another by bioinert regions;

FIG. 8 shows an arrangement of six monitoring cells, in a plan view of the lower parts of the monitoring cells; and

FIG. 9 shows a second embodiment of the monitoring cell according to the invention.

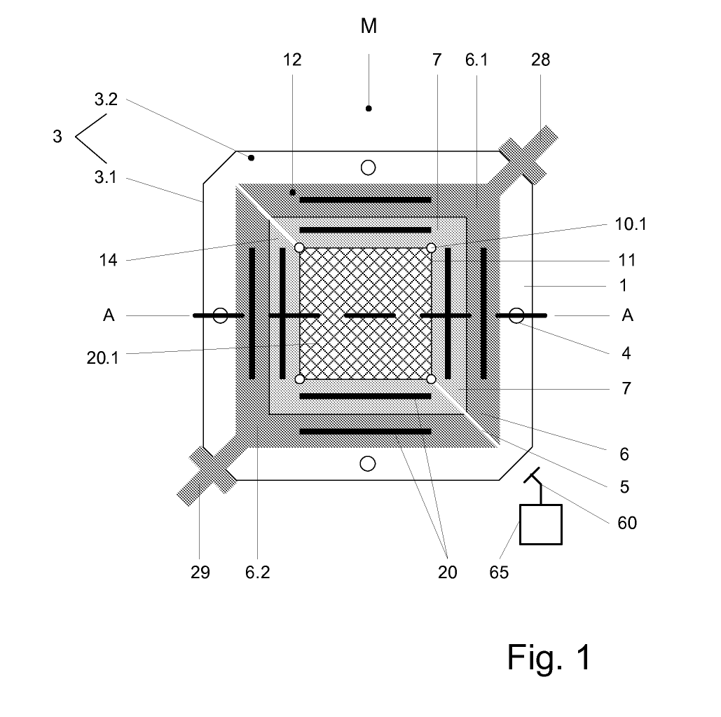

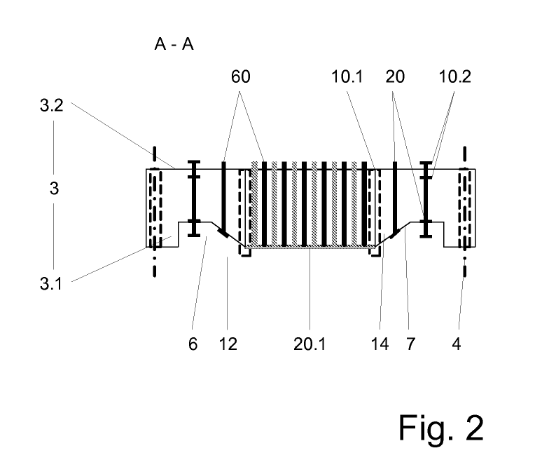

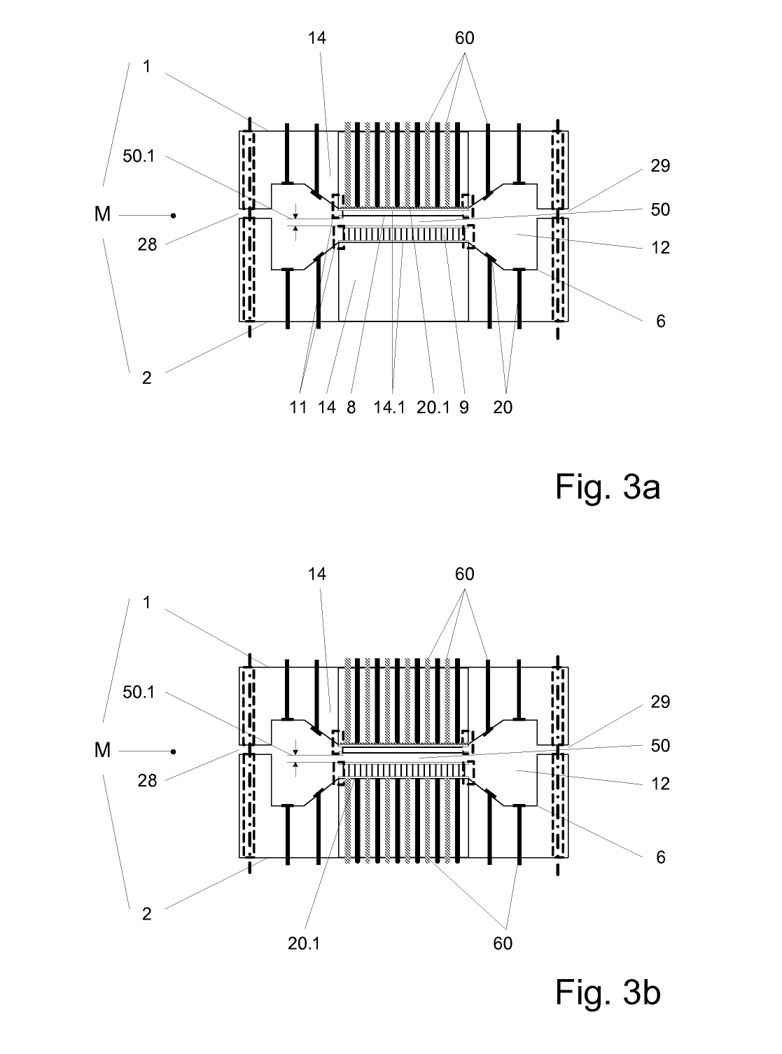

FIG. 1 shows an upper part 1 of a first embodiment of a monitoring cell M according to the invention. The essential elements are a housing 3 with encircling walls 3.1, which protrude toward the observer, and a base plate 3.2, with an upwardly open interior 12 with a square base area being surrounded by walls 3.1 and base plate 3.2, a projection 14 protruding into the interior 12 from the base plate 3.2, a holder device 11 for holding and affixing a carrier object 8 (see FIG. 3), a flow channel 6 formed between the projection 14 and the walls 3.1, electrodes 20, and a media feed 28 and a media discharge 29. The line A-A denotes the profile of a cut (see FIG. 2).

A lower part 2 (not shown) of the first exemplary embodiment of the monitoring cell M according to the invention has an identical design to the upper part 1. In the upper part 1 and in the lower part 2, bores 4 are present in the walls 3.1 and serve for the fluid-tight connection between upper part 1 and lower part 2 by means of screw connections (not shown) extending through the bores 4. The projection 14 protrudes as a frustum into the interior 12 in the center of the base plate 3.2 and has lateral edges 7 rising from the base plate 3.2 and an end face 14.1 extending parallel to the base plate 3.2 (see FIG. 3). Flow barriers 5 are present from the walls 3.1 to the end face 14.1 on one of the diagonals of the base area of the interior 12, as a result of which the flow channel 6 is subdivided into a first region 6.1 and a second region 6.2. On the other diagonal there is both the media feed 28, which is connected to the first region 6.1 in a fluidic fashion, and the media discharge 29, which is connected to the second region 6.2 in a fluidic fashion.

Electrodes 20 embodied as strip electrodes are arranged next to the end face 14.1 on all four sides. One electrode 20 is situated in the flow channel 6 and one electrode is situated on the edge 7 in each case, and so a total of eight electrodes 20 are arranged next to the end face 14.1 in a defined and known fashion. The entire end face 14.1 is covered by a central electrode 20.1 embodied as a plate electrode. This central electrode 20.1 can be adjusted in the direction of the end face 14.1 by means of a height adjuster 10.1. The holder device 11 is arranged laterally from the central electrode 20.1.

All connection lines 60 of the electrodes 20 and the central electrode 20.1 are installed extending through the walls 3.1 or through the base plate 3.2. The connection lines 60 serve as supply and measurement data lines. The electrodes 20, 20.1 are embodied and can be used as so-called actuator/sensor systems. In particular, they can be connected and actuated in accordance with such a system. Electric fields respectively defined in time and space can be generated in the interior 12 by the electrodes 20, 20.1 (actuator). The electrodes 20, 20.1 are also suitable for capturing electrical measurement data (sensor). The electrodes 20, 20.1 are connected to a control and computation unit 65 for signaling purposes.

In further embodiments of the monitoring cell, further measurement means such as chemical sensors or electrical sensors may be present at the height adjuster 10.1, in the interior 12 and/or in or at the media feed 28 and/or the media discharge 29 and connected to the control 65 for signaling purposes.

FIG. 2 shows an upper part 1 of a second embodiment of the monitoring cell M according to the invention, which has the elements mentioned in FIG. 1 and the central electrode 20.1 of which is formed as a cluster electrode from an arrangement (array) of individual electrodes 20. The connection lines 60 are routed through the base plate 3.2 of the housing 3. The height adjuster 10.1 is illustrated very schematically. The electrodes 20 arranged in the flow channel 6 are connected to a height adjuster 10.2 and pushed a distance into the interior 12 parallel to the wall 3.1. The electrodes 20 arranged on the edges 7 rest against the surface of the projection 14.

An assembled monitoring cell M according to the invention is shown in FIG. 3a. The upper part 1 and the lower part 2 have been placed on top of one another in such a way that the respective end faces 14.1 lie opposite to one another. On the end face 14.1 of the lower part 2, a cell substrate 9 is held and fixed by the holder device 11 of the lower part 2. On the end face 14.1 of the upper part 1, a carrier object 8 is held and fixed by the holder device 11 of the upper part 1. The free surfaces of carrier object 8 and cell substrate 9 lie opposite to one another and are separated by a gap 50 which has a gap width 50.1 of 650 μm. The holder devices 11 have a height-adjustable design such that the gap width 50.1 can be set. The upper part 1 and the lower part 2 have electrodes 20 in the interior 12. Additionally, there is a central electrode 20.1 in the form of a cluster electrode in the upper part 1. A medium coming from the media feed 28 flows through the interior 12 in the direction of the media discharge 29. Here, the walls 3.1 and the projection 14 form a flow path which extends along the flow channel 6 and through the gap 50. In further embodiments, in which flow barriers 5 are arranged, the flow path extends entirely or partly through the gap 50.

An embodiment illustrated in FIG. 3b additionally has a central electrode in the lower part 2. As a result, a measurement is also possible between the central electrodes 20.1, over the gap width 50.1 and through carrier object 8 and cell substrate 9.

There can be seals (not shown) between the upper part 1 and the lower part 2; moreover, the touching regions of the wall 3.1 can be designed differently, for example in a conical or stepped fashion.

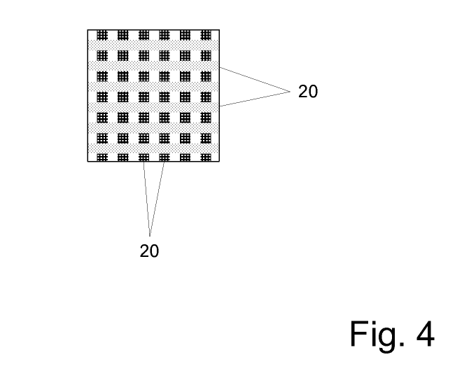

A first exemplary embodiment of a cluster electrode as per FIG. 4 is formed of electrically insulated, orthogonally crossing electrodes 20.

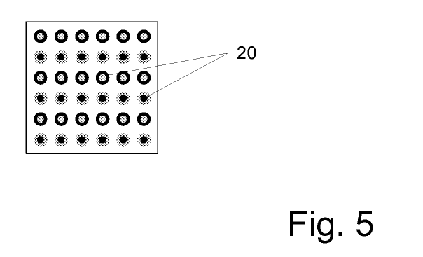

FIG. 5 shows a second exemplary embodiment of a cluster electrode, which consists of an array of electrodes 20 embodied as point-ring electrodes. The electrodes are arranged in rows, with a polarity of the electrodes 20 changing alternately from row to row.

In further embodiments of the monitoring cell according to the invention, a cluster electrode can also be embodied as a whole-area electrode or as a cluster electrode of mono-point electrodes which measures the potential field.

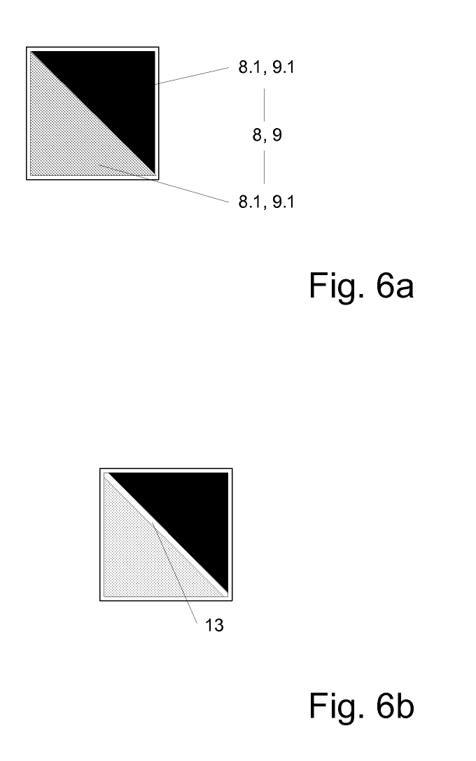

FIG. 6a shows a carrier object 8 which is subdivided into partial carrier objects 8.1, the partial carrier objects 8.1 of which butt directly against one another. The partial carrier objects 8.1 are materials with greatly varying surface roughness, as a result of which there is an interface situation between the partial carrier objects 8.1 which has a gap effect.

In FIG. 6b, a bioinert barrier zone 13 which is coated in a cytotoxic fashion and acts as a gap 50 is present between the partial carrier objects 8.1.

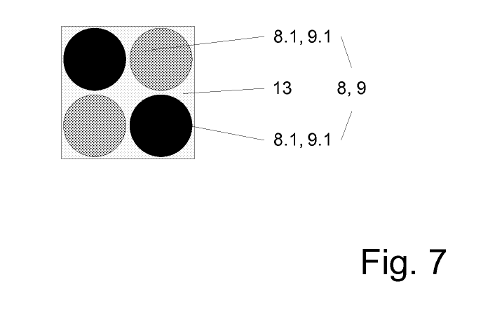

The descriptions provided for FIGS. 6 and 7 can respectively be transferred directly to cell substrates 9 or carrier objects 8, which is why the reference signs are allocated twice.

The partial carrier objects 8.1 can also have a surface which is graded in the x-direction or y-direction.

FIG. 7 shows cell substrates 9, which are organized into partial cell substrates 9.1. The partial cell substrates 9.1 are round and separated from one another by a bioinert barrier zone 13 which is coated in a cytotoxic fashion and acts as a gap 50.

In further embodiments, the subdivisions can also be formed in other shapes and sizes and with other spatial relationships. The barrier zone 13 can also be neutral in further embodiments.

In one exemplary embodiment (not shown), a first central electrode 20.1 is arranged, which is wholly or partly surrounded by a barrier 13 in a plane and over which there is a cell substrate 9. There is an annular carrier object 8 around the barrier 13. A second central electrode 20.1 is arranged opposite to the central electrode 20.1; the second central electrode 20.1 covers the first central electrode 20.1 with the cell substrate 9, the barrier 13 and the carrier object 8 in a plan view. A measurement is performed through the cell substrate 9 and/or between cell substrate 9 and carrier object 8.

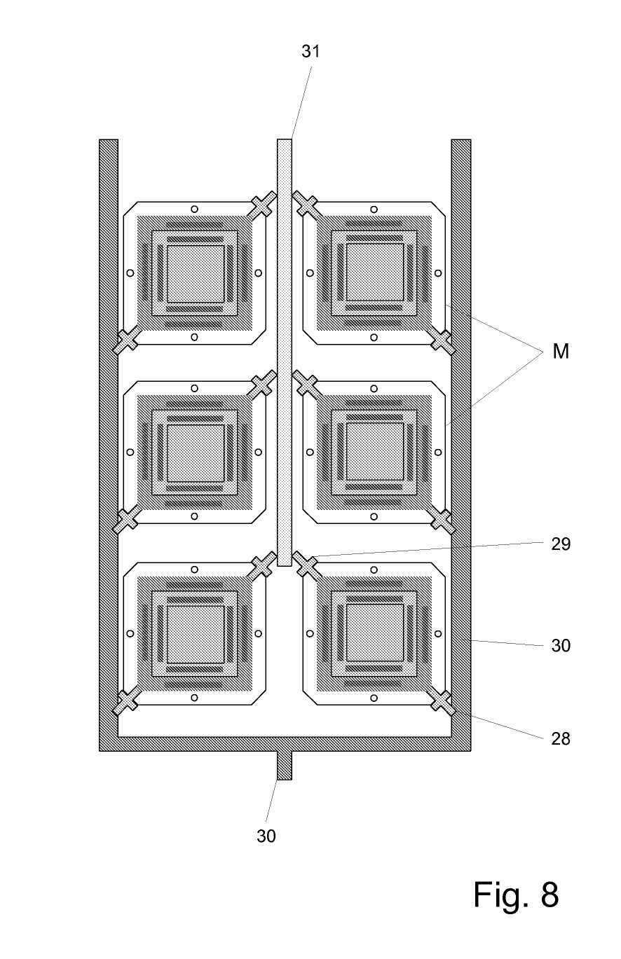

A plurality of the monitoring cells M according to the invention can be combined, as shown in FIG. 8. Analogously to so-called 6-well plates, six monitoring cells M are arranged in two columns and three rows. Each media feed 28 from each of the monitoring cells M is connected to a media feed line 30 and each media discharge 29 from each of the monitoring cells M is connected to a media discharge line 31.

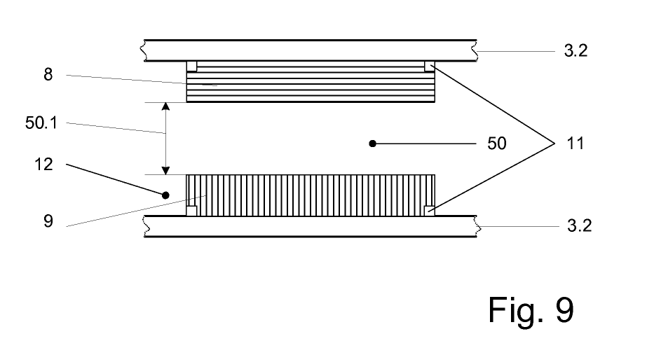

In a second embodiment of the monitoring cell M, shown in FIG. 9, there are no projections 14, but rather the holder devices 11 are respectively arranged on two base plates 3.2 extending parallel to one another in such a way that these holder devices protrude into the interior 12. The carrier object 8 is inserted and held in one of the holder devices 11 and the cell substrate 9 is inserted and held in the other holder device 11. A gap width of 1.5 mm is set between the surfaces of the carrier object 8 and of the cell substrate 9 which face the gap 50.

According to the invention, the aforementioned in vitro test arrangement serves for a non-test-abortive, multidimensional method for monitoring in vitro cell and tissue growth in a definable interface situation between a tissue-like region and a region in the form of degradable or non-degradable implant surfaces or tissue replacements. Thus it can be used to monitor growth processes in an in situ-like three-dimensional cell and tissue region with opposing boundary layers including a gap region.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

The disclosures of all documents mentioned above are incorporated by reference herein in their entireties.

### LIST OF REFERENCE SIGNS

1 Upper part (of the monitoring cell)
2 Lower part (of the monitoring cell)
3 Housing
3.1 Wall (of the housing 3)
3.2 Base plate
A-A Sectional plane
4 Connection bores
5 Flow barrier
6 Flow channel
6.1 First region (of the flow channel 6)
6.2 Second region (of the flow channel 6)
7 Edge (of the projection 14.1)
8 Carrier object
8.1 Partial carrier objects
9 Cell substrate
9.1 Partial cell substrate
10.1 Height adjuster (of the central electrode 20.1)
10.2 Height adjuster (of the electrode 20)
11 Holder device
12 Interior
13 Barrier zone
14 Projection
14.1 End face (of the projection 14)
20 Electrode
20.1 Central electrode
28 Media feed
29 Media discharge
30 Media feed line
31 Media discharge line
50 Gap
50.1 Gap width
60 Connection line
65 Control and computation unit

1.-24. (canceled)

25. A monitoring cell for analyzing cell and tissue growth, wherein the monitoring cell comprises (i) a housing with walls surrounding an interior and at least one base plate, the housing being provided with at least one feed for medium on at least one side of the interior, at least one discharge for medium on at least one other side of the interior, and a number of electrodes arranged in the interior, which electrodes are configured both for generating spatially and temporally defined electric and/or electromagnetic fields and for measuring electrical variables, (ii) at least one holder device for holding at least one carrier object and at least one holder device for holding at least one cell substrate or at least one holder device for holding at least one carrier object and at least one cell substrate, and (iii) at least at a start time of an analysis, a gap between the at least one carrier object and the at least one cell substrate such that an in vivo situation to be copied in vitro is reproduced between a carrier to be colonized and a substrate.

26. The monitoring cell of claim 25, wherein the interior comprises two projections with end faces, and the holder devices are arranged on the end faces.

27. The monitoring cell of claim 25, wherein further elements for measuring physical variables are arranged outside of the gap.

28. The monitoring cell of claim 25, wherein the cell further comprises an evaluation and storage unit that is connected to the electrodes and to further elements for measuring physical variables.

29. The monitoring cell of claim 25, wherein flow barriers whose arrangement results in medium being supplied to the gap are comprised in the interior.

30. The monitoring cell of claim 25, wherein the interior comprises projections, each projection comprising sloping edges.

31. The monitoring cell of claim 25, wherein the monitoring cell is connected to a controlled drive to allow the cell to be moved in a controlled fashion.

32. The monitoring cell of claim 25, wherein the holder devices are adjustable such that it is possible to set a gap width of the gap.

33. The monitoring cell of claim 32, wherein the gap width is less than 3 mm.

34. The monitoring cell of claim 25, wherein the interior comprises projections with end faces, and the electrodes are arranged next to the end faces on at least two sides.

35. The monitoring cell of claim 25, wherein the interior comprises projections with end faces, and at least one electrode is arranged on at least one end face as central electrode.

36. The monitoring cell of claim 25, wherein the at least one carrier object is subdivided into partial carrier objects.

37. The monitoring cell of claim 25, wherein the at least one cell substrate is subdivided into partial cell substrates.

38. A method for non-test-abortive, spatial-temporal in vitro monitoring of the growth of cells or tissues, wherein the method comprises:
accommodating a carrier object in a holder device of a monitoring cell,
accommodating a cell substrate in a further holder device of the monitoring cell such that there is a gap having a gap width between the carrier object and the cell substrate,
supplying a medium,
generating spatially and temporally defined electric and/or electromagnetic fields in the monitoring cell, and
capturing and storing measurement variables of the electric and/or electromagnetic fields.

39. The method of claim 38, wherein the medium is replaced at regular intervals.

40. The method of claim 38, wherein different media are supplied simultaneously or in succession.

41. The method of claim 38, wherein initial measurement variables in respect of an initial measurement time are captured and stored and the initial measurement variables are used as reference measurement variables for measurement variables captured at later measurement times.

42. The method of claim 38, wherein information in respect of the growth of cells or tissue is derived from changes in the measurement variables captured and stored at different measurement times.

43. The method of claim 38, wherein the measurement variables are captured in a spatially resolved fashion.

44. The method of claim 38, wherein measurement data captured in a spatially resolved fashion is represented graphically and information in respect of the growth of cells or tissue is derived from a corresponding graphical representation.

45. The method of claim 38, wherein information obtained by using the method is compared to a database.

46. The method of claim 38, wherein the growth of cells or tissue is influenced by a defined introduction of chemical substances into an interior of the monitoring cell.

47. The method of claim 38, wherein the growth of cells or tissue is influenced by defined coupling of physical effect factors into an interior of the monitoring cell.

48. The method of claim 38, wherein each gap width can be set to be less than 3 mm.
